(19) United States
(12) Patent Application Publication
(10) Pub. No.: US 2007/0140260 A1
(43) Pub. Date: Jun. 21, 2007

(54) System and method of single switch string hardware

(76) Inventors: Simon Duxbury, San Francisco, CA (US); Robert Ayrapetian, Morgan Hill, CA (US); Serob Douvalian, Daly City, CA (US)

Correspondence Address: STEVENS LAW GROUP, P.O. BOX 1667, SAN JOSE, CA, 95109, US

(21) Appl. No.: 11/593,858

(22) Filed: Nov. 6, 2006

Related U.S. Application Data
(60) Provisional application No. 60/733,963, filed on Nov. 4, 2005.
(60) Provisional application No. 60/733,966, filed on Nov. 4, 2005.

(51) Int. Cl. H04L 12/56

(52) U.S. Cl. 370/395.41

(57) ABSTRACT

An improved string switch architecture is provided having a partial shared memory. The string switch includes a plurality of input ports configured to classify incoming packets, wherein the destination output port and priority is determined at classification; a plurality of output ports, each having a string bank of memory units that compose the aggregate output queue memory for each port; a write manager configured to receive write requests and to write each packet directly to the appropriate memory location within each output port; where each output port includes an assignment block configured to receive packets originating from each input port; and a read manager configured to read data from the plurality of output ports. The write manager may be configured to write packet data received in a round robin fashion, which may be independent from the packet protocol.

### PRIORITY

This application claims the benefit of priority of U.S. patent application Ser. No. 11/400,367, filed Apr. 6, 2006, which claims the benefit of U.S. provisional patent application Ser. No. 60/669,028, filed Apr. 6, 2005.

This application also claims the benefit of U.S. provisional patent application Ser. No. 60/634,631, filed Dec. 8, 2004, U.S. provisional application No. 60/733,963 filed Nov. 4, 2006, and U.S. provisional patent application Ser. No. 60/733,966, filed Nov. 4, 2005.

### BACKGROUND

Switch fabrics typically fall into one of two categories:
1) Shared memory, output queued switches—in these switches, packets from all inputs are written/read to/from a common, shared physical memory. In this architecture, the switching is trivial, since every output port and every input port have access to the same memory, and switching is achieved by notifying each output port which packets in shared memory it needs to read out.
   Not surprisingly, the bottleneck in pure shared memory switches is the finite bandwidth of the shared memory. Since each port requires a write and read operation, the memory bandwidth required in a pure shared memory switch is 2*port_bit_rate*num_ports. For a 32 port, 10 Gbps Ethernet switch, 640 Gbps (80 GBytes/s) of memory bandwidth would be required for a shared memory switch.

This is too high for a reasonably priced single memory instance in today's technology.
2) Pure Crossbar fabrics (either input queued, Combined Input/Output Queued, or Crosspoint Buffered)—in these types of switch fabrics, a physical connection is made from input to output port through a non-shared memory fabric. These fabrics are either TDM based, or request/ack based.
   A disadvantage of using a pure crossbar fabric is the inherently blocking nature of the crossbar—if an input requests access to a particular output port which is not free, then packets behind the present packet (destined for other, ‘free’ outputs), are blocked. To get around this blocking problem, Virtual Output Queues are used at each input, meaning that the input to each crossbar has num_ports VOQs, and VOQs for which the output ports are free are serviced in a round robin fashion. The need for VOQs when using a pure crossbar greatly increases the total switch fabric solution cost, and makes single-switch chip implementation difficult. For a 32 port switch, a total of 32*32=1024 VOQs are required. Techniques exist for VOQ optimization, but the overall solution is still not particularly attractive for single-chip switches.

Thus, there exists a need in the art for a network switch that overcomes the shortcomings of the prior art. As will be seen, the invention overcomes these shortcomings in a novel and elegant manner.

### DETAILED DESCRIPTION

Reference is made to the attached appendix for a detailed embodiment produced in Verilog™.

The goal of the novel string switch fabric is to create a high performance switch fabric that can be implemented on a single chip in standard ASIC technologies. The string architecture has all the advantages of a shared memory architecture, with the performance of a crossbar architecture.

The novel ‘string’ based switch fabric is a specific implementation of a partial shared-memory, output queued switch. For each output port, there is a bank of memories, or ‘strings’, which, taken together, comprise the aggregate output queue memory for a given port. As packets arrive from each input port, they are classified, their output ports and priority are determined, and they are written directly to the appropriate string within each output port.

The locations in the string are chosen by the segment buffer assignment block. As chunks of packets from each input (64 bytes at a time) arrive at the input mux, a segment_number is assigned to each chunk. This segment number corresponds to a range of addresses in the String Memory, to which the chunk will be written. Since the input arbiter is operating on packet chunks and servicing each input in round robin fashion, the packet is represented as a linked list of segment numbers. The linked list is managed in the sb_cntl block. In a preferred embodiment, the String Memory is not necessarily FIFO based.

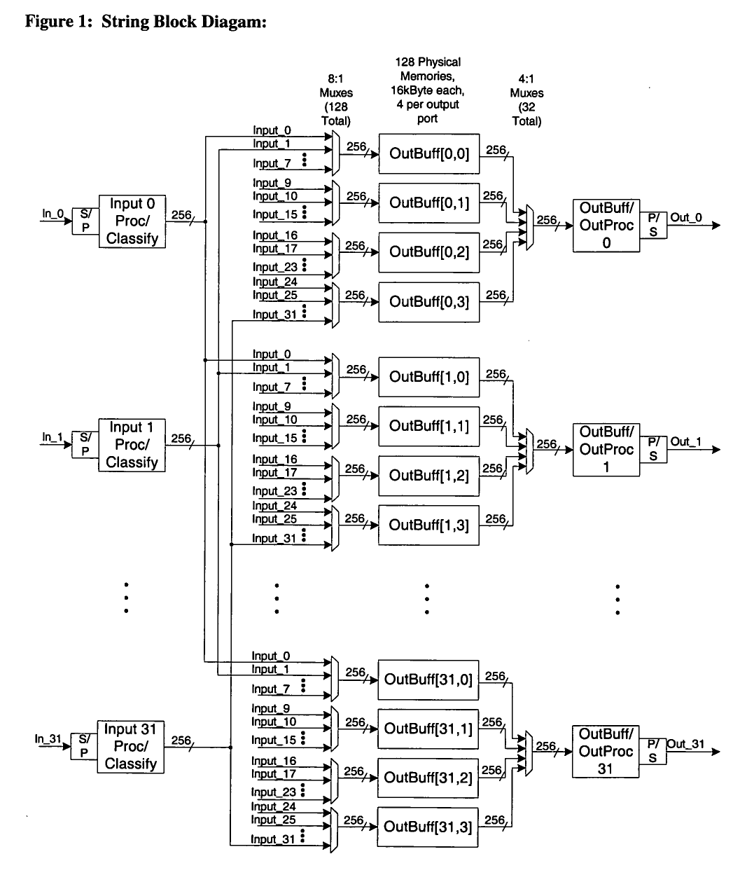

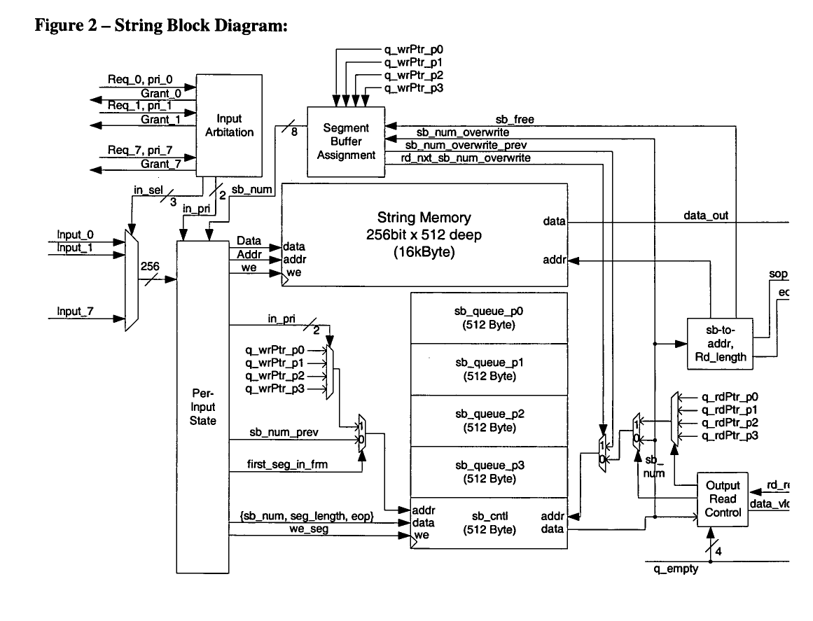

FIG. 1, below, is a high level block diagram of a particular implementation the string architecture (32 ports, 10 Gbps switch):

The data flow, from left to right, is as follows:
1) Input packets arrive at each Input Proc/Classify block, where their output port and output priority are determined
2) Once the output port and output priority of each input packet is determined, a request is generated to the appropriate mux arbiter of the appropriate output port.
3) Each Input is logically connected to each output by routing the Input bus to a mux input on every output.
4) Each OutBuff has a memory speedup of 8×, so it can simultaneously receive packets from 8 Inputs, leading to the 8:1 muxes at the input of each memory
5) The connection of Inputs to output muxes is as shown in FIG. 1. For example, Inputs[7:0] are always routed to OutBuff[outport_num, 0], Inputs[15:8] are always routed to OutBuff[outport_num, 1], etc.
6) Each OutBuff is a 16 KByte, dual port memory instance. This 16 KByte memory is shared among 8 Input ports, and is dynamically controlled for optimal memory utilization in the presence of congestion, with multiple priority levels taken into consideration (see the Packet Dropping Section).
7) The 4 OutBuffs for each output port are read on a first-come, first-serve round robin basis,
8) There are two modes of output operation:
   a. Normal Packet Buffer Mode—in this mode, a full packet is buffered before being streamed out. Errored packets are dropped (crc errors, long errors, etc.)
   b. Cut-through Mode—in this mode, only 64 bytes of the input packet are buffered before the packet is read out the interface, providing low latency operation. If, at the end of a packet, it is determined that the packet is in error, the output crc is optionally corrupted.
9) Performance simulations show that, under periods of congestion, the 16 KByte shared memory structure provides packet drop performance that is on-par with that of a pure shared memory switch.
10) High performance is achieved by having multiple memory instances (thus, gaining more memory BW), and still maintaining some level of memory sharing
   Fabric Speedup:

The number of strings required per output port is related to the speed-up factor that can be achieved when packets are buffered in each string memory. The higher the speedup factor, the fewer string memories are required per output port, and the greater the memory sharing factor.

In the 10 Gbps Ethernet case, a speedup factor of 8 is achieved, meaning that a single string memory can received packets from 8 inputs simultaneously, allowing the string memory to be shared among these 8 inputs. This speedup is achieved by having a core clock frequency of ˜400 MHz and a memory bus width of 256 bits (32 bytes). In this case, most of the speedup is achieved through the wide bus width, however, care must be taken when handling short packets through such a wide memory bus. Specifically, there is a loss in effective memory bandwidth when not all the bytes within a memory word are used for data (depending on how the packets are ‘packed’ into memory). For example, a 32 bit bus running at 312.5 MHz supports 10 Gbps if all memory words are completely occupied with data (the theoretically optimal case)—this would result in a speedup factor of 1 (32 bits×312.5 MHz=10 Gbps). In the novel design, the bus width is 256 bits, and packets are buffered in memory so that the first byte of the packet always starts on byte-lane 0 of the memory word. The table below indicates how packets are written to the memory:

| | | | | |
|---|---|---|---|---|
| Unused | Byte79 | Bytes66-78 | Byte65 | Byte64 |
| memory bytes | (packet 2) | (packet2) | (packet 2) | (packet 2) |

| Byte63 | Bytes34-62 | Byte33 | Byte32 |
|---|---|---|---|
| (packet 2) | (packet2) | (packet 2) | (packet 2) |
| Byte31 | Bytes2-30 | Byte1 | Byte0 |
| (packet 1) | (packet2) | (packet 2) | (packet 2) |
| Unused memory bytes | | | Byte64 |
| | | | (packet 1) |
| Byte63 | Bytes34-62 | Byte33 | Byte32 |
| (packet 1) | (packet1) | (packet 1) | (packet 1) |
| Byte31 | Bytes2-30 | Byte1 | Byte0 |
| (packet 1) | (packet1) | (packet 1) | (packet 1) |
| Byte63 | Bytes34-62 | Byte33 | Byte32 |
| (packet 0) | (packet0) | (packet 0) | (packet 0) |
| Byte31 | Bytes2-30 | Byte1 | Byte0 |
| (packet 0) | (packet0) | (packet 0) | (packet 0) |

In the table above, the first packet (packet0) is 64 bytes in length, and since each memory word is 32 bytes, the packet fits into the string without any memory or bandwidth waste. The second packet, however, is 65 bytes, which consumes 2 full memory words and a single byte of a third memory word while taking 3 memory write cycles to complete the packet. Since the minimum packet size for Ethernet is 64 bytes, a 65 byte packet represents the worst-case packet size from the standpoint of bandwidth and memory utilization.

To achieve a speedup of 8 in a 10 Gbps switch, 8*(10 Gbps)=80 Gbps of memory bandwidth is required in each string. With a 256 bit bus and a core clock of 312.5 MHz, a speedup of 8 is achieved if all memory bytes are used. However, since not all memory bytes are used, the core clock frequency must be increased to achieve a speedup of 8. To calculate the required core clock frequency for the worst case of 65 byte packets, the following equation is used:
8*(Effective Ethernet BW for 65 byte packets)=Effective Memory BW of string
80 Gbps*(65/(65+(ifg+preamble)))=core_{—}clk*256*(65/(65+unused_mem-bytes))
80 Gbps*(65/(65+13))=core_{—}clk*256*(65/(65+31))
80 Gbps*(0.833)=core_{—}clk*256*(0.677)
core_{—}clk=384.5 MHz

Therefore, the novel string achieves an effective speedup of at least 8 for all packet lengths by using a bus width of 256 bits and a core frequency of 384.5 MHz.

The total on-chip memory for the strings is 2 MByte, which leads to a per-string size of 16 kByte. Each string memory is implemented as a dual port memory, since packets need to be read out the string at the same time they are being written. Since the novel switch is 32×32 and each string handles 8 ports, 4 strings per output port are required. Packets are read out from each string in a round robin fashion (among strings that have packets).

Write Side Operation:

Basic Data Flow-

The string receives write requests with associated priority from 8 inputs. Each request is for a segment size of 64 bytes, or end-of-packet reception (eop), and similarly, each grant is for a segment size of 64 bytes or eop. If an eop is reached, the Input Arbitration block automatically moves to the next requesting input.

Each Input is serviced in 64 byte segment chunks (round robin). The reason for this is twofold:
1) to prevent the need for large input buffers in each Input Proc block—the Input is serviced frequently, so its buffering requirement is minimized
2) to operate in a fashion that is independent of a-priori (header-based) frame_length knowledge—some protocols contain the frame length in the header, some do not, and by operating without a-priori knowledge of the frame_length, the String architecture becomes completely protocol agnostic

Since the Inputs are serviced in 64 byte chunks and the length of each frame is not assumed to be known, the string memory is treated as a pool of 256, 64 byte segment buffers.

The Input Arbitration block decides which input to service in a round-robin fashion based on active input requests. Once a grant is given, the segment buffer is assigned and the data is written to the corresponding segment buffer in the string memory. Segment buffer management is performed by this block—once a segment buffer is assigned, it cannot be used until the segment data has been read out or the packet is overwritten (see packet drop section).

Since the String Memory is managed as a pool of segment buffers in which packets are composed of segments scattered throughout the memory, parallel data structures are implemented to manage the queueing of packets and the linked list of segments that compose a packet. The sb_queue_pX is written once per packet, and the write happens whenever the first segment of a packet has been completely written into the String Memory. There are four sb_queue's total, one for each priority level (4 priority level implementation), and, depending on the priority issued with the request, the appropriate sb_queue_mem is written. The sb_queue_mem is a straightforward fifo memory structure written once per packet with the {sb_num_first, seg_length, eop} as the data. The sb_num_first is the first segment number for the packet, and the seg_length determines the length of the segment (1 to 64 bytes). If the seg_length of the first segment is 64 bytes and the eop is present, no linked list for the packet is required. If, however, the length of the packet is greater than 64 bytes, the sb_cntl_mem is written on subsequent segment receptions, until the eop for the frame is received.

This architecture is not limited to 4 priority queues—the 4 priority queue diagram is meant for illustration and example only. Any number of priority levels can be implemented by adding extra sb_queue's and extending the bit width of the in_pri field.

The sb_cntl_mem is not a fifo—the address for the present entry is the previous segment buffer number that was assigned for the packet. The entry contains the same data as that in the sb_queue_mem: {sb_num, seg_length, eop}. For long packets, multiple sb_cntl_mem entries are used, with the present sb_num always pointing to the address of the next entry. When an eop is reached, the list for that packet is terminated.

Packet Dropping-

The String hardware does not give any back-pressure to the Input Processing Blocks. If the String Memory becomes full, input requests are still accepted and packets that cannot be stored due to lack of memory are dropped. Since the TCP algorithm retransmits from the first point of drop detection within a flow, it is desirable for the present (or most recent) incoming packet to be dropped, rather than overwriting an earlier packet within the flow. There are two different cases for dropping packets:
1. String Memory becomes full and there are no packets in the string that are lower priority—in this case, the incoming packet is dropped by removing its sb_queue entry and blocking all we_seg's.
2. String Memory becomes full and there are lower priority packets in the string—in this case, the incoming packet overwrites lower priority packets in the buffer by using the string space that is occupied by the lower priority packet(s), traversing and utilizing the lower priority packet's linked list. Multiple lower priority link lists may be required if the incoming higher priority packet is long—lower priority link lists are consumed as required.

The advantages of the packet dropping mode (2) above are:
1. The string memory is optimally utilized for multiple priority queues. With the overwriting strategy, no memory is reserved for any particular priority queue—the entire string memory can be used by any priority level. Once congestion is encountered, the memory allocation among the multiple priority levels is dynamically re-assigned through the overwriting mechanism
2. High priority packets are guaranteed to preempt lower priority packets in the string memory, thereby minimizing the packet drops for high priority queues. Only in the case in which congestion occurs among high priority flows will a high priority packet be dropped.
3. The sb_cntl/sb_queue structure allows the overwriting to be implemented in a straightforward fashion—lower priority packets that need to be overwritten are de-queued from the sb_queue, and their sb_cntl linked list is traversed by the higher priority packet.
   Detail of Segment Buffer Assignment:

The segment buffer assignment block is responsible for assigning segment buffers for incoming packets. This block maintains the list of available segment buffers, and acquires segment buffers from lower priority link lists for overwriting lower priority packets with higher priority packets when the string becomes full.

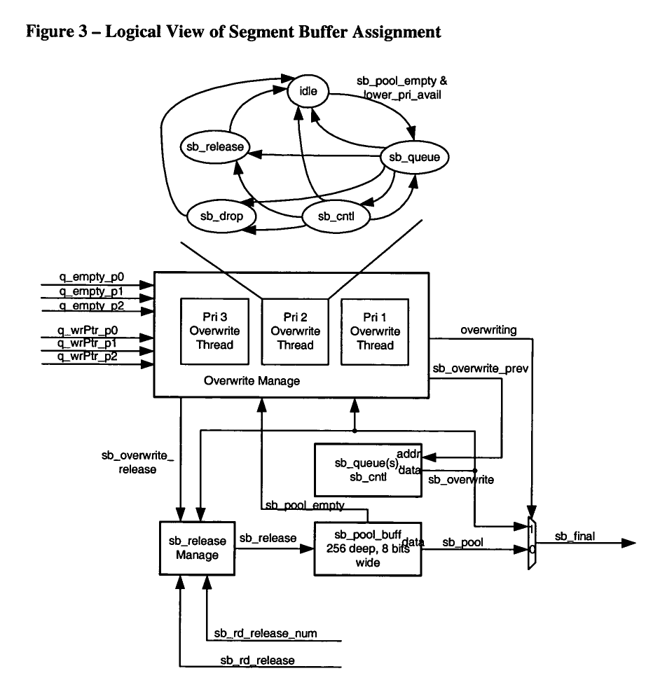

FIG. 3, below, shows a conceptual view of how the segment buffers are managed and assigned:

In FIG. 3, above, there are the following elements:
1) The sb_queue/sb_cntl block represents the combined memory of the sb_queues (one for each priority) and the sb_cntl data structure.
2) The sb_pool_buff represents the initial pool-of-segment_buffers—this is initialized with all the available segment buffers (0-255) at reset
3) The Overwrite Manage block represents the logical block required for assigning segments from lower priority packets that are already in the string
4) The sb_release Manage block arbitrates among outstanding requests for segment_buffer releases. Segments buffers are released when their data is read out the buffer, or there are unused segment buffers that remain from the use of a lower priority linked list.

In general, the assigned segment buffer (sb_final), comes from either the sb_pool_buff (in the case of no congestion), or the sb_queue/sb_cntl (in the case of congestion).

When there is no congestion, the sb_pool_buff will not be empty, and segment buffers are assigned by reading the sb_pool_buff. The sb_pool_buff is a simple fifo structure that holds are the available segment buffers. When read, the sb_pool_buff produces a segment buffer, and once the data in a segment buffer has been read out the interface, the segment buffer is returned to the sb_pool_buff by writing the sb_rd_release_num back into the sb_pool_buff.

If congestion occurs, the sb_pool_buff will be drained, as the packet arrival rate is 8× that of the packet read rate. When the sb_pool_buff becomes empty, sb_pool_empty is asserted, and the String memory is full.

When the sb_pool_buff is empty, the Overwrite Manage block determines if there is a lower priority linked-list available to overwrite by examining the q_empty_p[2:0]. If a lower priority list is available, the first segment buffer in that list is acquired by reading the value from sb_queue_pX[q_wrPtr_pX−1]. The next segment buffer is acquired by reading sb_cntl[sb_num_prev], and so on, until the eop for that linked list is reached.

Incoming packets that are overwriting a lower priority linked-list can span multiple lower-priority linked lists.

The Overwrite Thread machine is expanded in FIG. 3, and it shows how the overwrite_state changes from sb_queue to sb_cntl, then on to multiple states, depending on the length of the linked-list that is overwritten.

If the linked list is greater than the incoming packet, then the remaining segment buffers are released before the state machine goes to IDLE. If the linked list is less than the incoming packet, then the state machine transitions from sb_cntl to sb_queue (if another lower priority linked list is available). Finally, if the incoming packet length exceeds the capacity of all lower priority link-lists, the incoming packet is dropped.

Three concurrent Overwrite Threads are required—one for each incoming priority. If incoming packets from multiple inputs have the same priority, the Overwrite Thread for these inputs is shared. If incoming packets from multiple inputs have different priorities, then the three Overwrite Threads can be concurrently active, each reading segment buffers and overwriting linked-lists from different existing queues in memory.

Read Side Operation:

The sb_queue_pX are the main queues for reading data out of the string structure—these are the fifo queues that determine the order in which packets are read out. At each packet boundary, the highest priority sb_queue_pX that is non-empty is chosen as the next packet/linked-list. For low latency, packets are moved from the String Memory to the final OutBuf as soon as sb_queue_mem is not empty (64 bytes are available), and once started, the entire packet must be moved to the OutBuf (no mixing of packets in the OutBuf, since this is a simple fifo). If required (packet>64 bytes), the linked-list for that packet is traversed in the sb_cntl until the eop is reached.

The invention has been described as an improved string switch architecture, in the context of a network switch having a partial shared memory. The string switch includes a plurality of input ports configured to classify incoming packets, wherein the destination output port and priority is determined at classification; a plurality of output ports, each having a string bank of memory units that compose the aggregate output queue memory for each port; a write manager configured to receive write requests and to write each packet directly to the appropriate memory location within each output port; where each output port includes an assignment block configured to receive packets originating from each input port; and a read manager configured to read data from the plurality of output ports. The write manager may be configured to write packet data received in a round robin fashion, which may be independent from the packet protocol.

1. A network switch having a partial shared memory; comprising:
a plurality of input ports configured to classify incoming packets, wherein the destination output port and priority is determined at classification.
a plurality of output ports, each having a string bank of memory units that compose the aggregate output queue memory for each port;
a write manager configured to receive write requests and to write each packet directly to the appropriate memory location within each output port;
each output port including an assignment block configured to receive packets originating from each input port; and
a read manager configured to read data from the plurality of output ports.

2. A network switch according to claim 1, wherein the write manager is configured to write packet data received in a round robin fashion.

3. A network switch according to claim 1, wherein the write manager is configured to write packet data received in a round robin fashion that is independent from the packet protocol.
